(19) United States
(12) Patent Application Publication
(10) Pub. No.: US 2021/0125575 A1
(43) Pub. Date: Apr. 29, 2021

(54) DISPLAY DEVICE AND DRIVE METHOD THEREOF

(71) Applicant: Sharp Kabushiki Kaisha, Sakai City (JP)

(72) Inventors: Jun NISHIMURA, Sakai City (JP); Takuya WATANABE, Sakai City (JP); Akira TAGAWA, Sakai City (JP); Yasuaki IWASE, Sakai City (JP); Yohei TAKEUCHI, Sakai City (JP)

(21) Appl. No.: 17/064,677

(22) Filed: Oct. 7, 2020

Related U.S. Application Data
(60) Provisional application No. 62/925,792, filed on Oct. 25, 2019.

(51) Int. Cl. G09G 3/36; G09G 3/20

(52) U.S. Cl. CPC G09G 3/3688; G09G 2310/0297; G09G 3/2092; G09G 3/3677

(57) ABSTRACT

A demultiplexing circuit provided in a display device including an active matrix substrate includes demultiplexers respectively corresponding to sets of source bus line groups obtained by dividing source bus lines in the active matrix substrate into groups with two or more source bus lines making up one set, and input terminals respectively corresponding to the demultiplexers. Each demultiplexer includes two or more main switching elements respectively corresponding to two or more source bus lines of the corresponding set, and two or more sub-switching elements respectively connected in parallel with the two or more main switching elements, the input terminals are respectively connected to the two or more source bus lines via the two or more main switching elements, and each of the two or more sub-switching elements is controlled to be turned off at a time later than a time when the corresponding main switching element is turned off.

### BACKGROUND

### 1. Field

The present disclosure relates to a display device including an active matrix substrate, and more particularly, to a display device including a demultiplexer for time-divisionally applying data signals output from a data drive circuit to two or more data signal lines in a corresponding active matrix substrate and a drive method thereof.

### 2. Description of the Related Art

Display devices such as an active matrix liquid crystal display device use an active matrix substrate in which a plurality of data signal lines (also referred to as “source bus lines”), a plurality of scanning signal lines (also referred to as “gate bus lines”) intersecting the plurality of data signal lines, and a plurality of pixel forming units arranged in a matrix along the plurality of data signal lines and the plurality of scanning signal lines are formed. In some of the display devices, a method is employed in which a plurality of data signal lines in the active matrix substrate are divided into a plurality of sets of data signal line groups with two or more data signal lines making up one set, and data signals are time-divisionally applied to two or more data signal lines in each set (hereinafter referred to as a “source shared driving (SSD) method”).

In the SSD method, a plurality of demultiplexers are used corresponding to the plurality of sets, and a data drive circuit outputs a plurality of data signals to the plurality of demultiplexers, respectively. Each demultiplexer includes two or more switching elements that are respectively connected to two or more data signal lines of the corresponding set. As a data signal from the data drive circuit, an analog voltage is applied to one of the two or more data signal lines via an on-state switching element of the two or more switching elements in the demultiplexer, and the switching elements in each demultiplexer are sequentially switched to the on-state. When the switching element connected to each data signal line is in the on-state in the demultiplexer, a data signal is applied to the data signal line the via the switching element, and then, when the switching element changes to the off-state, the analog voltage as the data signal is held in a wiring capacitor thereof. When one of the plurality of scanning signal lines is activated (selected) in a state where the analog voltage as the data signal is applied to or held in each data signal line as described above, the voltage of the data signal line is written as pixel data in the pixel forming unit connected to the activated scanning signal line.

In the active matrix display device employing the SSD method, when after the analog voltage is applied to each data signal line via the switching element that is in the on-state, the switching element changes to the off-state by changing the level of a control signal of the switching element, the voltage held in the data signal line becomes lower or higher than the original voltage as the data signal, due to parasitic capacitance (this phenomenon is referred to as a “field-through phenomenon” or a “feed-through phenomenon”). For example, when the switching element is an N-channel transistor and the voltage applied to a gate terminal as a control terminal (hereinafter referred to as a “gate voltage”) is changed from a high level (H level) to a low level (L level) to put the switching element to the off-state, the voltage held in the corresponding data signal line becomes lower than the original voltage as the data signal, due to the influence of the change in the gate voltage via the parasitic capacitance. On the other hand, when the switching element is a P-channel transistor and the voltage applied to a gate terminal as the control terminal (gate voltage) is changed from the L level to the H level to put the switching element to the off-state, the voltage held in the corresponding data signal line becomes higher than the original voltage as the data signal, due to the influence of the change in the gate voltage via the parasitic capacitance.

Incidentally, in the display device including the active matrix substrate using the SSD method, it is normal that each switching element in the demultiplexer changes from the off-state to the on-state and then changes from the on-state to the off-state in each horizontal period. That is, the number of toggles of each switching element in the demultiplexer is twice per horizontal period. With regard to such a display device using the SSD method, a configuration of reducing the number of toggles to reduce power consumption (hereinafter referred to as a “toggle-number reducing configuration”) has been proposed (for example, International Publication No. 2018/190245, paragraphs [0170] to [0173]).

When the toggle-number reducing configuration is employed, each demultiplexer includes a switching element that changes from the on-state to the off-state and a switching element that does not change from the on-state to the off-state, in each horizontal period. Therefore, one set of data signal line groups connected to each demultiplexer includes a data signal line in which the feed-through phenomenon occurs and a data signal line in which the feed-through phenomenon does not occur in each horizontal period, resulting in deterioration of display quality. In particular, when a large-sized transistor is used as a switching element in each demultiplexer, a significant difference occurs in the voltage held between the data signal line in which the feed-through phenomenon occurs and the data signal line in which the feed-through phenomenon does not occur, which causes a significant deterioration of display quality.

Therefore, in the display device including the active matrix substrate using the SSD method, it is desirable to suppress deterioration of the display quality due to the feed-through phenomenon of the data signal line while reducing power consumption.

### SUMMARY

According to an aspect of the disclosure, there is provided a display device including an active matrix substrate provided with a plurality of data signal lines, a plurality of scanning signal lines intersecting the plurality of data signal lines, and a plurality of pixel forming units arranged along the plurality of data signal lines and the plurality of scanning signal lines. The display device includes a demultiplexing circuit that includes a plurality of demultiplexers respectively corresponding to a plurality of sets of data signal line groups obtained by dividing the plurality of data signal lines into groups with two or more data signal lines making up one set, and a plurality of input terminals respectively corresponding to the plurality of demultiplexers, a data drive circuit that applies, to each of the plurality of input terminals, a signal into which two or more data signals are time-division multiplexed as a multiplexed data signal, the two or more data signals being respectively applied to the two or more data signal lines in the set corresponding to the input terminal, among a plurality of data signals representing an image to be displayed, and a demultiplexing control circuit that generates a demultiplexing control signal for controlling the demultiplexing circuit such that the plurality of data signals are respectively applied to the plurality of data signal lines. Each of the plurality of demultiplexers includes two or more main switching elements respectively corresponding to the two or more data signal lines in the corresponding set, the main switching elements each having a first conduction terminal connected to the corresponding data signal line, a second conduction terminal connected to the input terminal corresponding to the demultiplexer, and a control terminal for receiving a connection control signal for switching between an on-state and an off-state based on the demultiplexing control signal, and two or more sub-switching elements respectively corresponding to the two or more main switching elements, the sub-switching elements each having first and second conduction terminals respectively connected to the first and second conduction terminals of the corresponding main switching element, and a control terminal for receiving a connection control signal for switching between the on-state and the off-state based on the demultiplexing control signal, and the demultiplexing control circuit generates the demultiplexing control signal such that each of the two or more sub-switching elements included in each of the plurality of demultiplexers is turned off at a point in time later than a point in time when the corresponding main switching element is turned off.

According to another aspect of the disclosure, there is provided a drive method of a display device that includes an active matrix substrate provided with a plurality of data signal lines, a plurality of scanning signal lines intersecting the plurality of data signal lines, and a plurality of pixel forming units arranged along the plurality of data signal lines and the plurality of scanning signal lines. The display device includes a demultiplexing circuit that includes a plurality of demultiplexers respectively corresponding to a plurality of sets of data signal line groups obtained by dividing the plurality of data signal lines into groups with two or more data signal lines making up one set, and a plurality of input terminals respectively corresponding to the plurality of demultiplexers. Each of the plurality of demultiplexers includes two or more main switching elements respectively corresponding to the two or more data signal lines in the corresponding set, the main switching elements each having a first conduction terminal connected to the corresponding data signal line, a second conduction terminal connected to the input terminal corresponding to the demultiplexer, and a control terminal for receiving a connection control signal for switching between an on-state and an off-state, and two or more sub-switching elements respectively corresponding to the two or more main switching elements, the sub-switching elements each having first and second conduction terminals respectively connected to the first and second conduction terminals of the corresponding main switching element, and a control terminal for receiving a connection control signal for switching between the on-state and the off-state. The drive method includes applying, to each of the plurality of input terminals, a signal into which two or more data signals are time-division multiplexed, the two or more data signals being respectively applied to the two or more data signal lines in the set corresponding to the input terminal, among a plurality of data signals representing an image to be displayed, and controlling the main switching elements and the sub-switching elements in the demultiplexing circuit such that the plurality of data signals are respectively applied to the plurality of data signal lines. In the controlling, the two or more main switching elements and the two or more sub-switching elements are controlled such that each of the two or more sub-switching elements included in each of the plurality of demultiplexers is turned off at a point in time later than a point in time when the corresponding main switching element is turned off.

These and other objects, features, aspects and effects of the present invention will become more apparent from the following detailed description of the present invention with reference to the accompanying drawings.

### BRIEF DESCRIPTION OF THE DRAWINGS

FIG. 1 is a block diagram showing an overall configuration of a display device including an active matrix substrate according to a first embodiment;

FIG. 2 is a circuit diagram showing a configuration of a demultiplexing circuit in the first embodiment together with an electrical configuration of a display unit;

FIG. 3 is a signal waveform diagram for describing an operation of the demultiplexing circuit in the first embodiment;

FIG. 4 is a circuit diagram showing a configuration of a demultiplexing circuit (demultiplexing circuit in an example of the related art) in an active matrix substrate of the related art;

FIG. 5 is a signal waveform diagram (A, B) showing, as a comparative example, a simulation result of a charging operation of a source bus line via the demultiplexing circuit in the example of the related art shown in FIG. 4;

FIG. 6A is a diagram for describing an effect of the first embodiment, and shows a simulation result of a charging operation of a source bus line when a size of a transistor in the demultiplexing circuit is changed;

FIG. 6B is a diagram for describing an effect of the first embodiment, and shows a simulation result of a relationship between a feed-through voltage generated by the demultiplexing circuit and the size of the transistor;

FIG. 7A is a diagram for describing an effect of the first embodiment, and shows a simulation result of the charging operation of the source bus line when a connection off time difference between a main connection control transistor and a sub-connection control transistor in the demultiplexing circuit is changed;

FIG. 7B is a diagram for describing an effect of the first embodiment, and shows a simulation result of a relationship between the feed-through voltage generated by the demultiplexing circuit and the connection off time difference;

FIG. 8 is a signal waveform diagram (A, B) showing an operation of the demultiplexing circuit when the size of the transistor and the connection off time difference are set such that the (substantial) feed-through voltage in the first embodiment is minimized based on the simulation results shown in FIGS. 7A and 7B;

FIG. 9 is a circuit diagram showing a configuration of a demultiplexing circuit in an active matrix substrate according to a second embodiment;

FIG. 10 is a signal waveform diagram for describing an operation of the demultiplexing circuit in the second embodiment;

FIG. 11 is a circuit diagram showing a configuration of a demultiplexing circuit in an active matrix substrate according to a third embodiment;

FIG. 12A is a diagram for describing terminals of a boost circuit included in the demultiplexing circuit shown in FIG. 11;

FIG. 12B is a circuit diagram showing a configuration of the boost circuit; and

FIG. 13 is a signal waveform diagram for describing an operation of the demultiplexing circuit in the third embodiment.

### DESCRIPTION OF THE EMBODIMENTS

Hereinafter, embodiments will be described with reference to the accompanying drawings. Note that, in each transistor described below, a gate terminal corresponds to a control terminal, one of a drain terminal and a source terminal corresponds to a first conduction terminal, and the other corresponds to a second conduction terminal. Further, it is assumed that the transistors in each of the following embodiments are all N-channel thin film transistors, but the present disclosure is not limited thereto. The present disclosure can be applied when a field effect transistor is used in a demultiplexing circuit described below regardless of whether it is an N-channel type or a P-channel type. Further, the term “connection” in the present specification means “electrical connection” unless otherwise specified, and as long as it does not depart from the gist of the present disclosure, not only the case where it means a direct connection but also the case where it means an indirect connection via another element is included.

### 1. First Embodiment

### 1.1 Overall Configuration and Operation Overview

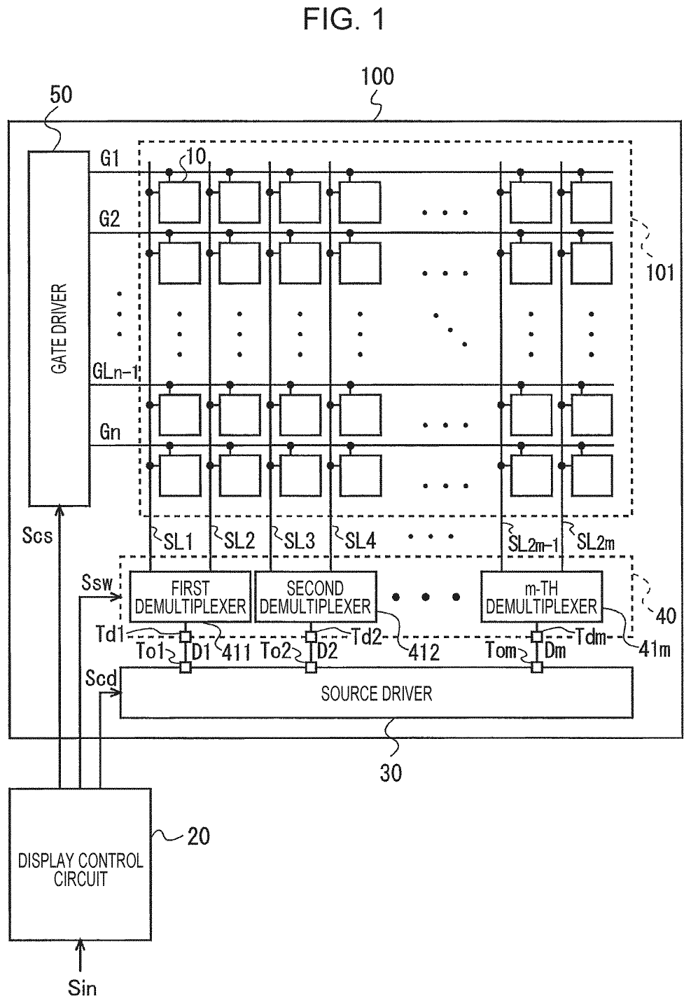

FIG. 1 is a block diagram showing an overall configuration of a liquid crystal display device including an active matrix substrate 100 using an SSD method according to a first embodiment (hereinafter, referred to as a “display device of the first embodiment”). On the active matrix substrate 100, a display unit 101 is formed, a gate driver 50 as a scanning signal line drive circuit and a demultiplexing circuit 40 are formed, and further, a source driver 30 as a data drive circuit is mounted (for example, COG mounting). The liquid crystal display device includes a display control circuit 20 in addition to the active matrix substrate 100 and the source driver 30 mounted thereon. An input signal Sin is applied to the display control circuit 20 from the outside, and the input signal Sin includes an image signal representing an image to be displayed and a timing control signal for displaying the image. Note that, in the liquid crystal display device, in order to narrow the frame of the display unit and reduce the number of output terminals and the amount of the circuit of the data drive circuit, a demultiplexer is integrally formed with a pixel forming unit on the active matrix substrate (hereinafter, the SSD method realized by using such a demultiplexer is referred to as a “monolithic SSD method”). However, the present embodiment is not limited to the monolithic SSD method, and a demultiplexer may be included in a driver integrated circuit (IC) mounted on the active matrix substrate 100, for example.

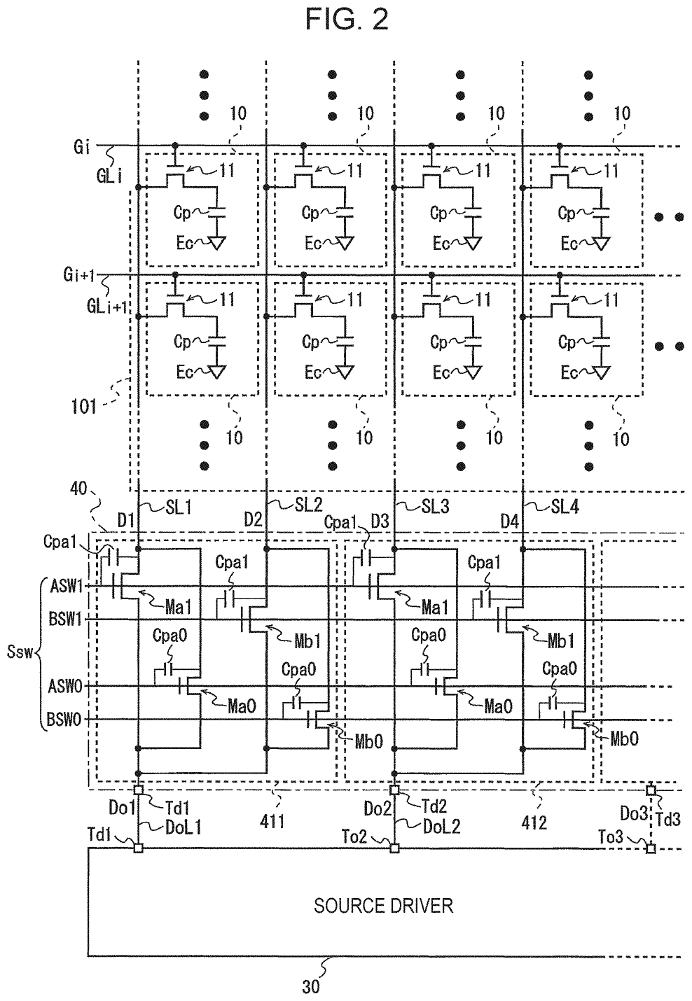

FIG. 2 is a circuit diagram showing a configuration of the demultiplexing circuit 40 in the active matrix substrate 100 according to the present embodiment together with an electrical configuration of a display unit 101. As shown in FIGS. 1 and 2, in the display unit 101 on the active matrix substrate 100, a plurality of (2m) source bus lines SL1 to SL2m as data signal lines, a plurality of (n) gate bus lines GL1 to GLn as scanning signal lines, and a plurality of (n×2m) pixel forming units 10 arranged in a matrix along the source bus lines SL1 to SL2m and the gate bus lines GL1 to GLn are arranged.

Each pixel forming unit 10 corresponds to any one of the source bus lines SL1 to SL2m, and corresponds to any one of the gate bus lines GL1 to GLn, and each pixel forming unit is connected to the corresponding gate bus line GLi and source bus line SLj (1≤i≤n, 1≤j≤2m).

As shown in FIG. 2, each pixel forming unit 10 includes a thin film transistor (hereinafter abbreviated as “TFT”) 11 as a switching element in which the gate terminal is connected to the corresponding gate bus line GLi and the source terminal is connected to the corresponding source bus line SLj, a pixel electrode Ep connected the drain terminal of the TFT 11, a common electrode Ec commonly provided in n×2m pixel forming units 10, and a liquid crystal layer that is sandwiched between the pixel electrode Ep and the common electrode Ec and is commonly provided in the n×2m pixel forming units 10. Then, a pixel capacitor Cp is formed by a liquid crystal capacitor formed by the pixel electrode Ep and the common electrode Ec. Typically, an auxiliary capacitor is provided in parallel with the liquid crystal capacitor in order to reliably hold the voltage in the pixel capacitor Cp, but since the auxiliary capacitor is not directly related to the present disclosure, description and illustration thereof are omitted.

As the TFT 11 in the pixel forming unit 10, a thin film transistor using amorphous silicon for a channel layer, a thin film transistor using low temperature polysilicon for the channel layer (LTPS-TFT), a thin film transistor using an oxide semiconductor for the channel layer (hereinafter referred to as an “oxide TFT”), and the like can be employed. As the oxide TFT, for example, a thin film transistor having an oxide semiconductor layer containing an In—Ga—Zn—O-based semiconductor (for example, indium gallium zinc oxide) can be employed. In the present embodiment, it is assumed that an oxide TFT is used as the TFT 11 in the pixel forming unit 10. The gate driver 50 and the demultiplexing circuit 40 are integrally formed with the pixel forming unit 10 on the active matrix substrate 100, and it is assumed that the oxide TFT is also used for the TFT in the demultiplexing circuit 40.

The display control circuit 20 receives the input signal Sin from the outside, and generates and outputs a data control signal Scd, a scanning side control signal Scs, a demultiplexing control signal Ssw, and a common voltage Vcom (not shown) based on the input signal Sin. The data control signal Scd is applied to the source driver 30 as a data drive circuit, the scanning side control signal Scs is applied to the gate driver 50 as a scanning signal line drive circuit, and the demultiplexing control signal Ssw is applied to the demultiplexing circuit 40, respectively. Thereby, the display control circuit 20 controls the source driver 30 and the gate driver 50, and also controls the demultiplexing circuit 40. As described above, in the present embodiment, the circuit for controlling the demultiplexing circuit 40, that is, the demultiplexing control circuit is included in the display control circuit 20, but it may be separated from the display control circuit 20 or may be provided in the source driver 30 or the gate driver 50.

The gate driver 50 generates scanning signals G1, G2, . . . , Gn for sequentially selecting n gate bus lines GL1, GL2, . . . , GLn based on the scanning side control signal Scs to apply them to the n gate bus lines GL1, GL2, . . . , GLn, respectively. By driving the gate bus lines GL1 to GLn by the gate driver 50 as described above, the n gate bus lines GL1 to GLn are sequentially selected for one horizontal period, and such sequential selection of the n gate bus lines GL1 to GLn is repeated with one frame period as a cycle. Here, the “horizontal period” refers to a period of a portion corresponding to one line of a display image in a video signal based on horizontal scanning and vertical scanning. Note that the gate bus lines GL1 to GLn may be sequentially selected for each of a plurality of horizontal periods (for example, two horizontal periods).

The data control signal Scd applied to the source driver 30 includes an image signal Sv representing an image to be displayed and a data timing control signal Sct (for example, a start pulse signal or a clock signal). The source driver 30 drives the source bus lines SL1 to SL2m via the demultiplexing circuit 40 by generating and outputting data output signals Do1 to Dom, at a timing corresponding to the driving of the gate bus lines GL1 to GLn by applying the scanning signals G1 to Gn, based on such a data control signal Scd (details will be described below). Generally, in the display device using the SSD method, the source bus lines in the active matrix substrate are divided into a plurality of sets of source bus line groups with two or more source bus lines making up one set, and the source driver includes a plurality of output terminals respectively corresponding to the plurality of sets as output terminals for driving the source bus lines. As shown in FIG. 2, in the present embodiment, the 2m source bus lines SL1 to SL2m in the active matrix substrate 100 are divided into m sets of source bus line groups (SL1, SL2), (SL3, SL4), . . . , (SL2m−1, SL2m) with two source bus lines SL2k−1 and SL2k making up one set. The source driver 30 includes m output terminals To1 to Tom corresponding to the m sets as output terminals for driving the source bus lines. The data output signal Dok output from each output terminal Tok (k=1 to m) is a signal in which data signal D2k−1 and D2k to be respectively applied to the two source bus lines SL2k−1 and SL2k of the corresponding set are time-division multiplexed (hereinafter referred to as a “multiplexed data signal”).

The demultiplexing circuit 40 is integrally formed with the n×2m pixel forming units 10 of the display unit 101 on the active matrix substrate 100, receives multiplexed data signals Do1 to Dom from the source driver 30, and demultiplexes these multiplexed data signals Do1 to Dom based on the demultiplexing control signal Ssw to apply them as 2m data signals D1 to D2m to the source bus lines SL1 to SL2m, respectively.

As described above, the data signals D1 to D2m are applied to the source bus lines SL1 to SL2m, and the scanning signals G1 to Gn are applied to the gate bus lines GL1 to GLn. Further, the common voltage Vcom is supplied from the display control circuit 20 to the common electrode Ec. By driving the source bus lines SL1 to SL2m and the gate bus lines GL1 to GLn in the display unit 101 as described above, pixel data is written in each pixel forming unit 10 based on the image signal Sv in the input signal Sin, and the back surface of the display unit 101 is irradiated with light from a backlight (not shown), so that the image represented by the image signal Sv is displayed on the display unit 101.

### 1.2 Details of Configuration and Operation of Demultiplexing Circuit

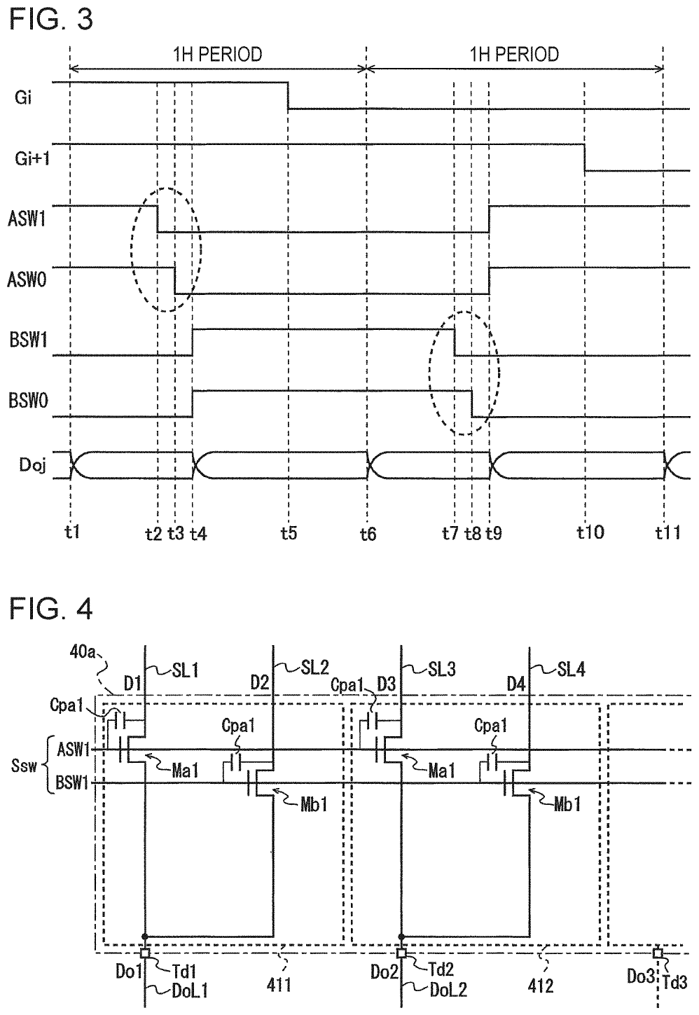

FIG. 3 is a signal waveform diagram for describing an operation of the demultiplexing circuit 40 in the present embodiment. Hereinafter, the configuration and operation of the demultiplexing circuit 40 will be described in detail with reference to FIG. 3 together with FIG. 2 described above.

As shown in FIG. 2, the demultiplexing circuit 40 in the present embodiment includes m demultiplexers 411, 412, 413, . . . , 41m respectively corresponding to the m sets of source bus line groups (SL1, SL2), (SL3, SL4), . . . , (SL2m−1, SL2m), and has m input terminals Td1 to Tdm respectively corresponding to the m demultiplexers 411 to 41m. The m input terminals Td1 to Tdm are connected to the m output terminals To1 to Tom of the source driver 30 via data output lines DoL1 to DoLm, respectively, and the multiplexed data signals Do1 to Dom output from the source driver 30 are applied to the input terminals Td1 to Tdm of the demultiplexing circuit 40, respectively. Each demultiplexer 41k (k=1 to m) connects the data output line DoLk connected to the corresponding input terminal Tdk to one of the two source bus lines SL2k−1 and SL2k of the corresponding set, based on the demultiplexing control signal Ssw, and switches the source bus line connected to the data output line DoLk between the two source bus lines SL2k−1 and SL2k in each horizontal period. Thereby, the multiplexed data signal Dok applied to each input terminal Tdk of the demultiplexing circuit 40 is demultiplexed and applied to the two source bus lines SL2k−1 and SL2k of the corresponding set as data signals D2k−1 and D2k.

Further, as shown in FIG. 2, each demultiplexer 41k (k=1 to m) in the demultiplexing circuit 40 includes two TFTs (hereinafter referred to as “main connection control transistors”) Ma1 and Mb1 as main switching elements, which are respectively connected to the two source bus lines SL2k-1 and SL2k of the corresponding set. The input terminal Tdk corresponding to the demultiplexer 41k among the m input terminals Td1 to Tdm is connected to one source bus line SL2k−1 of the two source bus lines via one main connection control transistor Ma1 of the two main connection control transistors and is also connected to the other source bus line SL2k via the other connection control transistor Mb1.

Further, in each demultiplexer 41k (k=1 to m), two main connection control transistors Ma1 and Mb1 are connected in parallel with two sub-connection control transistors Ma0 and Mb0 as sub-switching elements, respectively. That is, the two main connection control transistors Ma1 and Mb1 correspond to the two sub-connection control transistors Ma0 and Mb0, respectively, and the source terminal and the drain terminal of each of the two main connection control transistors Ma1 and Mb1 are respectively connected to the source terminal and the drain terminal of the corresponding sub-connection control transistor. Therefore, the input terminal Tdk corresponding to each demultiplexer 41k is connected to the 2k−1-th source bus line SL2k−1 via one main connection control transistor Ma1 and is also connected to the 2k−1-th source bus line SL2k−1 via one sub-connection control transistor Ma0, or is connected to the 2k-th source bus line SL2k via the other main connection control transistor Mb1 and is also connected to the 2k-th source bus line SL2k via the other sub-connection control transistor Mb0. In the present embodiment, the respective sizes (correctly, channel widths) of the sub-connection control transistors Ma0 and Mb0 are smaller than the respective sizes (correctly, channel widths) of the main connection control transistors Ma1 and Mb1, but they may be the same. Note that, hereinafter, for convenience, the conduction terminal, which is connected to the source bus line, of the two conduction terminals in each of the main connection control transistors Ma1 and Mb1 will be referred to as the drain terminal. The same applies to the sub-connection control transistors Ma0 and Mb0.

As shown in FIG. 2, a parasitic capacitance Cpa1 is formed between a gate terminal and a drain terminal of each main connection control transistor Mx1 (x=a, b), and when the voltage of the gate terminal changes from a low level (L level) to a high level (H level), the voltage held in a source bus line (SL2k−1 or SL2k) connected to the main connection control transistor Mx1 is affected by the voltage change via the parasitic capacitance Cpa1 (as described above, this phenomenon is referred to as a “field-through phenomenon” or a “voltage feed-through phenomenon”). Similarly, a parasitic capacitance Cpa0 is formed between a gate terminal and a drain terminal of each sub-connection control transistor Mx0 (x=a, b), and when the voltage of the gate terminal changes from the L level to the H level, the voltage held in a source bus line (SL2k−1 or SL2k) connected to the sub-connection control transistor Mx0 is affected by the voltage change via the parasitic capacitance Cpa0.

The demultiplexing control signal Ssw applied to the demultiplexing circuit 40 includes an A main control signal ASW1, a B main control signal BSW1, an A sub-control signal ASW0, and a B sub-control signal BSW0 as shown in FIG. 3, and four signal lines for respectively transmitting these control signals ASW1, BSW1, ASW0, and BSW0 are arranged in the demultiplexing circuit 40. As shown in FIG. 2, in each demultiplexer 41k, out of the two source bus lines SL2k−1 and SL2k connected to the demultiplexer, the A main control signal ASW1 and the A sub-control signal ASW0 are respectively applied to the gate terminals of the main connection control transistor (hereinafter referred to as an “A main control transistor) Ma1 and the sub-connection control transistor (hereinafter referred to as an “A sub-control transistor) Ma0 connected to the source bus line SL2k−1 with the smaller number, and the B main control signal BSW1 and the B sub-control signal BSW0 are respectively applied to the gate terminals of the main connection control transistor (hereinafter referred to as a “B main control transistor) Mb1 and the sub-connection control transistor (hereinafter referred to as a “B sub-control transistor) Mb0 connected to the source bus line SL2k with the larger number.

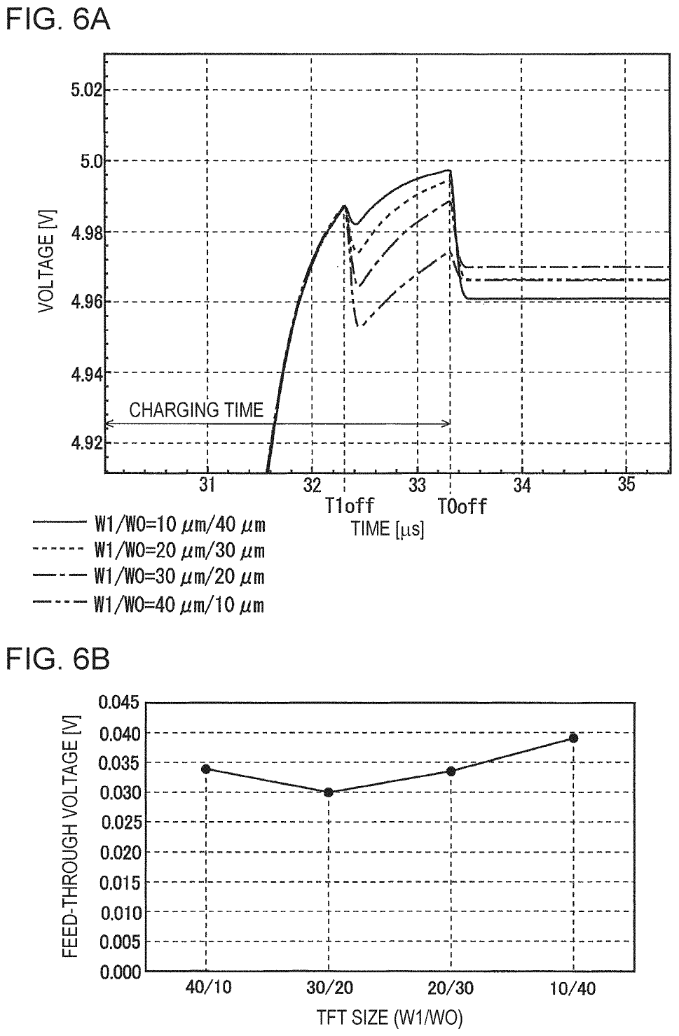

The demultiplexing circuit 40 configured as described above operates as follows based on the demultiplexing control signal Ssw (the A main control signal ASW1, the B main control signal BSW1, the A sub-control signal ASW0, and the B sub-control signal BSW0) from the display control circuit 20, thereby demultiplexing the multiplexed data signals Do1 to Dom output from the source driver 30 and applying them as 2m data signals D1 to D2m to the source bus lines SL1 to SL2m, respectively. Hereinafter, referring to FIGS. 6A and 6B, such an operation of the demultiplexing circuit 40 will be described in detail by focusing on the k-th demultiplexer 41k (1≤k=m).

As shown in FIG. 3, at a start point in time t1 (time t1) of the i-th 1H period (horizontal period) in a certain frame period, the voltage of the multiplexed data signal Dok input from the source driver 30 to the demultiplexer 41k changes to the voltage of the data signal D2k−1 to be written in the pixel forming unit 10 corresponding to the i-th gate bus line GLi and the 2k−1-th source bus line SL2k−1 (data voltage to be written in the pixel forming unit 10 in the i-th row and the 2k−1-th column). At time t1, since the A main control signal ASW1 and the A sub-control signal ASW0 are maintained at the H level, the A main control transistor Ma1 and the A sub-control transistor Ma0 are in the on-state. On the other hand, since the B main control signal BSW1 and the B sub-control signal BSW0 are maintained at the L level, the B main control transistor Mb1 and the B sub-control transistor Mb0 are in the off-state. Therefore, the voltage of the multiplexed data signal Dok is applied to the 2k−1-th source bus line SL2k−1 via the A main control transistor Ma1, and is also applied to the 2k−1-th source bus line SL2k−1 via the A sub-control transistor Ma0.

After that, at time t2, the A main control signal ASW1 changes from the H level to the L level, and the A main control transistor Ma1 enters the off-state. At this time, the voltage change of the A main control signal ASW1 from the H level to the L level affects the voltage of the 2k−1-th source bus line SL2k−1 via the parasitic capacitance Cpa1 of the A main control transistor Ma1 and reduces the voltage (hereinafter, the amount of voltage drop at this time is referred to as a “feed-through voltage due to turn-off of the A main control transistor Ma1”). However, at time t2, since the A sub-control transistor Ma0 is maintained in the on-state, the voltage of the source bus line SL2k−1 changes from the reduced voltage to the original voltage (see FIG. 6A described below).

After that, at time t3, the A sub-control signal ASW0 changes from the H level to the L level, and the A sub-control transistor Ma0 enters the off-state. At this time, the voltage change of the A sub-control signal ASW0 from the H level to the L level affects the voltage of the 2k−1-th source bus line SL2k−1 via the parasitic capacitance Cpa0 of the A sub-control transistor Ma0 and reduces the voltage (hereinafter, the amount of voltage drop at this time is referred to as a “feed-through voltage due to turn-off of the A sub-control transistor”) again, and the voltage after the reduction is held in the source bus line SL2k−1. However, as described above, since the size of the A sub-control transistor Ma0 is smaller than the size of the A main control transistor Ma1, a capacitance value of the parasitic capacitance Cpa0 of the A sub-control transistor Ma0 is smaller than a capacitance value of the parasitic capacitance Cpa1 of the A main control transistor Ma1. Therefore, the feed-through voltage (absolute value) due to turn-off of the A sub-control transistor Ma0 at this time is smaller than the feed-through voltage (absolute value) due to turn-off of the A main control transistor Ma1. Note that, even if the capacitance values of both parasitic capacitances Cpa0 and Cpa1 are the same, the feed-through voltages (absolute values) of them are smaller than in the case of the related art. This is because the capacitance value of each of the parasitic capacitances Cpa0 and Cpa1 is smaller than a capacitance value of a parasitic capacitance of each transistor as a switching element in the demultiplexer of the related art as described below.

After that, at time t4, both the B main control signal BSW1 and the B sub-control signal BSW0 change from the L level to the H level, and the B main control transistor Mb1 and the B sub-control transistor Mb0 enter the on-state. At this time, the voltage of the multiplexed data signal Dok input to the demultiplexer 41k changes to the voltage of the data signal D2k to be written in the pixel forming unit 10 corresponding to the i-th gate bus line GLi and the 2k-th source bus line SL2k (data voltage to be written in the pixel forming unit 10 in the i-th row and the 2k-th column). Therefore, after time t4, the voltage of the multiplexed data signal Dok is applied to the 2k-th source bus line SL2k via the B main control transistor Mb1 as the voltage of such a data signal D2k, and is also applied to the 2k-th source bus line SL2k via the B sub-control transistor Mb0.

After that, at time t5, the i-th scanning signal Gi changes from the H level to the L level, and the i-th gate bus line GLi enters a non-selected state. Thereby, the writing of the voltage held in the 2k-th source bus line SL2k to the pixel forming unit 10 corresponding to the i-th gate bus line GLi and the 2k-th source bus line SL2k is ended.

After that, at time t6, the i-th 1H period ends and the i+1-th 1H period starts. At time t6, the voltage of the multiplexed data signal Dok input to the demultiplexer 41k changes to the voltage of the data signal D2k to be written in the pixel forming unit 10 corresponding to the i+1-th gate bus line GLi+1 and the 2k-th source bus line SL2k (data voltage to be written in the pixel forming unit 10 in the i+1-th row and the 2k-th column). Therefore, after time t6, the voltage of the multiplexed data signal Dok is applied to the 2k-th source bus line SL2k via the B main control transistor Mb1 as the voltage of the data signal D2k corresponding to the i+1-th display line, and is also applied to the 2k-th source bus line SL2k via the B sub-control transistor Mb0.

After that, at time t7, the B main control signal BSW1 changes from the H level to the L level, and the B main control transistor Mb1 enters the off-state. At this time, the voltage change of the B main control signal BSW1 from the H level to the L level affects the voltage of the 2k-th source bus line SL2k via the parasitic capacitance Cpa1 of the B main control transistor Mb1 and reduces the voltage (hereinafter, the amount of voltage drop at this time is referred to as a “feed-through voltage due to turn-off of the B main control transistor Mb1”). However, at time t7, since the B sub-control transistor Mb0 is maintained in the on-state, the voltage of the source bus line SL2k changes from the reduced voltage to the original voltage (see FIG. 6A described below).

After that, at time t8, the B sub-control signal BSW0 changes from the H level to the L level, and the B sub-control transistor Mb0 enters the off-state. At this time, the voltage change of the B sub-control signal BSW0 from the H level to the L level affects the voltage of the 2k-th source bus line SL2k via the parasitic capacitance Cpa0 of the B sub-control transistor Mb0 and reduces the voltage (hereinafter, the amount of voltage drop at this time is referred to as a “feed-through voltage due to turn-off of the B sub-control transistor”) again. However, as described above, since the size of the B sub-control transistor Mb0 is smaller than the size of the B main control transistor Mb1, a capacitance value of the parasitic capacitance Cpa0 of the B sub-control transistor Mb0 is smaller than a capacitance value of the parasitic capacitance Cpa1 of the B main control transistor Mb1. Therefore, the feed-through voltage (absolute value) due to turn-off of the B sub-control transistor Mb0 at this time is smaller than the feed-through voltage (absolute value) due to turn-off of the B main control transistor Mb1. Note that, similar to the above, even if the capacitance values of both parasitic capacitances Cpa0 and Cpa1 are the same, the feed-through voltages (absolute values) of them are smaller than in the case of the related art.

After that, at time t9, both the A main control signal ASW1 and the A sub-control signal ASW0 change from the L level to the H level, and the A main control transistor Ma1 and the A sub-control transistor Ma0 enter the on-state. At this time, the voltage of the multiplexed data signal Dok input to the demultiplexer 41k changes to the voltage of the data signal D2k−1 to be written in the pixel forming unit 10 corresponding to the i+1-th gate bus line GLi+1 and the 2k−1-th source bus line SL2k−1 (data voltage to be written in the pixel forming unit 10 in the i+1-th row and the 2k−1-th column). Therefore, after time t9, the voltage of the multiplexed data signal Dok is applied to the 2k−1-th source bus line SL2k−1 via the A main control transistor Ma1 as the voltage of such a data signal D2k−1, and is also applied to the 2k−1-th source bus line SL2k−1 via the A sub-control transistor Ma0.

After that, at time t10, the i+1-th scanning signal Gill changes from the H level to the L level, and the i+1-th gate bus line GLi+1 enters the non-selected state. Thereby, the writing of the voltage held in the 2k−1-th source bus line SL2k−1 to the pixel forming unit 10 corresponding to the i+1-th gate bus line GLi+1 and the 2k−1-th source bus line SL2k−1 is ended.

As described above, for each 1H period, the voltages of the multiplexed data signals Do1 to Dom output from the source driver 30 are demultiplexed and respectively applied to and held by the source bus lines SL1 to SL2m as the voltages of the data signals D1 to D2m. The voltages applied to and held by the source bus lines SL1 to SL2m are line-sequentially written as data voltages in the n×2m pixel forming units 10 of the display unit 101 in accordance with the scanning of the gate bus lines GL1 to GLn.

Note that in the present embodiment, the toggle-number reducing configuration is employed, and as can be seen from FIGS. 2 and 3, the number of times each of the main connection control transistors Ma1 and Mb1 and the sub-connection control transistors Ma0 and Mb0 in each demultiplexer 41k changes from the on-state to the off-state or from the off-state to the on-state, that is, the number of toggles is once per 1H period (the same applies to second and third embodiments described below). With such a toggle-number reducing configuration, power consumption is reduced compared to the configuration of the related art in which the number of toggles of each switching element in each demultiplexer is twice per 1H period.

### 1.3 Comparative Example of Driving Source Bus Line Via Demultiplexer

Next, driving of the source bus line via a demultiplexing circuit (hereinafter referred to as a “demultiplexing circuit in the example of the related art”) 40a in the active matrix substrate shown in FIG. 4, which does not include the above-described sub-connection control transistors Ma0 and Mb0, is considered as a comparative example of driving the source bus lines SL1 to SL2m via the demultiplexing circuit 40 in the present embodiment. In the comparative example described below, a demultiplexing circuit in an active matrix substrate used in a medium-sized high-definition display (17-inch display with a resolution equivalent to ultra high definition (UHD)) for a laptop computer, in which thin film transistors (oxide TFT) having a channel layer formed of an oxide semiconductor are used as the main connection control transistors Ma1 and Mb1, is assumed as the demultiplexing circuit 40a in the example of the related art. The charging operation of the source bus line by driving the source bus line via the demultiplexing circuit 40a will be described below.

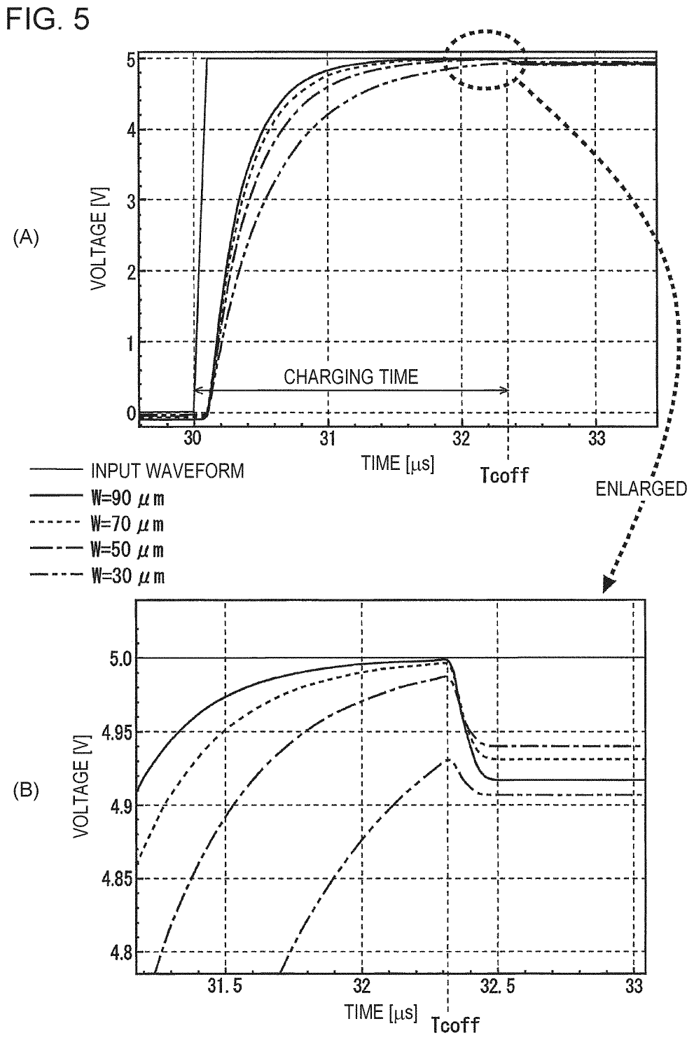

FIG. 5 is a signal waveform diagram showing a simulation result of the charging operation of the source bus line via the demultiplexing circuit 40a. In (A) and (B) of FIG. 5, the thin solid line shows a waveform of the multiplexed data signal Dok input from the source driver to the demultiplexer 41k of the demultiplexing circuit 40a, that is, an input waveform, and the thick solid line shows a waveform of the data signal D2k−1 or D2k applied from the demultiplexer 41k to the source bus line SL2k−1 or SL2k when the signal Dok of the input waveform is input to the demultiplexing circuit 40a using the main connection control transistors Ma1 and Mb1 with a channel width W of 90 μm, that is, a voltage waveform (hereinafter referred to as an “output waveform”) of the source bus line connected to an on-state connection control transistor (hereinafter referred to as a “selection transistor”, indicated by the symbol “MS1”) of the main connection control transistors Ma1 and Mb1. The thick dotted line shows an output waveform when the signal Dok of the input waveform is input to the demultiplexer 41k using the connection control transistors Ma1 and Mb1 with the channel width W of 70 μm. The thick one-dot chain line shows an output waveform when the signal Dok of the input waveform is input to the demultiplexer 41k using the main connection control transistors Ma1 and Mb1 with the channel width W of 50 μm. The thick two-dot chain line shows an output waveform when the signal Dok of the input waveform is input to the demultiplexer 41k using the main connection control transistors Ma1 and Mb1 with the channel width W of 30 μm.

As shown in (A) of FIG. 5, the input waveform rises from 0 V to 5 V at the point in time when 30 μs has elapsed from a reference time (point in time of 0 μs) (hereinafter referred to as a “30 μs elapsed point in time”), and the connection control transistor (selection transistor) Ms1 in the on-state changes to the off-state at a predetermined elapsed point in time (at the point in time indicated by the symbol “Tcoff” in (A) of FIG. 5). At the point in time indicated by the Tcoff (hereinafter referred to as a “connection off point in time”), the voltage of a control signal (hereinafter, indicated by the symbol “SSW1”), which is applied to the gate terminal of the selection transistor Ms1, of the A control signal ASW1 and the B control signal BSW1 in the demultiplexing control signal Ssw changes from the H level to the L level, and this voltage change reduces the voltage of the output waveform via the parasitic capacitance Cpa1. That is, a field-through phenomenon occurs in the output waveform at the connection off point in time Tcoff. (B) of FIG. 5 is an enlarged view showing the output waveform before and after the connection off point in time Tcoff in which the field-through phenomenon occurs.

As can be seen from (B) of FIG. 5, in the comparative example, when the channel width W of the selection transistor Ms1 (Ma1, Mb1) in the demultiplexing circuit 40a is 30 μm, the voltage of the output waveform at the connection off point in time Tcoff is low, the source bus line is insufficiently charged. In contrast, when the channel width W is 90 μm or 70 μm, the voltage of the output waveform at the connection off point in time Tcoff at which the selection transistor Ms1 is turned off is high, but the amount of voltage drop (feed-through voltage) due to the field-through phenomenon thereafter is large. In simulation results shown in (B) of FIG. 5, since the voltage of the output waveform after the voltage drop due to the field-through phenomenon is the highest when the channel width W is 50 μm, it can be said that the source bus line is best charged when the channel width W is 50 μm. Therefore, hereinafter, W=50 μm is regarded as the optimum value of the channel width.

### 1.4 Effect

FIG. 6A is a signal waveform diagram showing a simulation result of the charging operation of the source bus line via the demultiplexing circuit 40 (see FIG. 2) in the present embodiment, and corresponds to the enlarged view of (B) of FIG. 5 showing the simulation result of the comparative example. In the simulation for obtaining the results of FIGS. 6A and 6B, it is assumed that an oxide TFT is used as the main connection control transistors Ma1 and Mb1 and the sub-connection control transistors Ma0 and Mb0 in the demultiplexing circuit 40. Further, in the comparative example as described above, considering that the optimum value of the channel width W of the selection transistor Ms1 (Ma1, Mb1) is 50 μm, it is assumed that the charging operation of the source bus line when channel widths W1 and W0 are changed is simulated under the condition that the total W1+W0 of the channel width W1 of the main connection control transistors Ma1 and Mb1 and the channel width W0 of the sub-connection control transistors Ma0 and Mb0 in each demultiplexer 41k is 50 μm.

Also in the simulation for obtaining the result of FIG. 6A, it is assumed that the waveform of the multiplexed data signal Dok input from the source driver 30 to the demultiplexing circuit 40, that is, the input waveform rises from 0 V to 5 V at the point in time when 30 μs has elapsed from the reference time (point in time of 0 μs) (30 μs elapsed point in time), as in the comparative example (see (A) of FIG. 5 and (B) of FIG. 5). In FIG. 6A, the thick solid line shows a waveform of the data signal D2k−1 or D2k applied from the demultiplexer 41k to the source bus line SL2k−1 or SL2k when the signal Dok of the input waveform is input to the k-th demultiplexer 41k of the demultiplexing circuit 40 using the main connection control transistors Ma1 and Mb1 with a channel width W1 of 10 μm and the sub-connection control transistors Ma0 and Mb0 with a channel width W0 of 40 μm, that is, a voltage waveform (hereinafter also referred to as an “output waveform”) of the source bus line connected to the on-state main connection control transistor of the main connection control transistors Ma1 and Mb1. The thick dotted line shows an output waveform when the signal Dok of the input waveform is input to the k-th demultiplexer 41k using the main connection control transistors Ma1 and Mb1 with the channel width W1 of 20 μm and the sub-connection control transistors Ma0 and Mb0 with the channel width W0 of 30 μm. The thick one-dot chain line shows an output waveform when the signal Dok of the input waveform is input to the k-th demultiplexer 41k using the main connection control transistors Ma1 and Mb1 with the channel width W1 of 30 μm and the sub-connection control transistors Ma0 and Mb0 with the channel width W0 of 20 μm. The thick two-dot chain line shows an output waveform when the signal Dok of the input waveform is input to the k-th demultiplexer 41k using the main connection control transistors Ma1 and Mb1 with the channel width W1 of 40 μm and the sub-connection control transistors Ma0 and Mb0 with the channel width W0 of 10 μm.

In the present embodiment as described above, in each demultiplexer 41k, the A main control transistor Ma1 and the A sub-control transistor Ma0 change to the on-state at the same time, but the point in time to change to the off-state is slightly different, and the A sub-control transistor Ma0 changes to the off-state after the A main control transistor Ma1 changes to the off-state (see FIG. 3). The relationship between the timing at which the B main control transistor Mb1 is turned on/off and the timing at which the B sub-control transistor Mb0 is turned on/off is similar. In the example shown in FIG. 6A, in the k-th demultiplexer 41k, at the point in time indicated by the symbol “T1off” (hereinafter referred to as a “main connection off point in time”), the transistor in the on-state of the A main control transistor Ma1 and the B main control transistor Mb1 (hereinafter referred to as a “main selection transistor”, indicated by the symbol “Ms1”) changes to the off-state, and then, at the point in time indicated by the symbol “T0off” (hereinafter referred to as a “sub-connection off point in time”), the transistor in the on-state of the A sub-control transistor Ma0 and the B sub-control transistor Mb0, that is, the transistor connected in parallel with the main selection transistor Ms1 of the A sub-control transistor Ma0 and the B sub-control transistor Mb0 (hereinafter referred to as a “sub-selection transistor”, indicated by the symbol “Ms0”) changes to the off-state. Note that, in the simulation for obtaining the result of FIG. 6A, the time difference between the sub-connection off point in time T0off and the main connection off point in time T1off (ΔToff=T0off−T1off) is fixed at 1.0 μs.

A feed-through voltage ΔV0 at the sub-connection off point in time T0off which is the end point in time of charging of the source bus line, which is connected to the main selection transistor Ms1 and the sub-selection transistor Ms0, of the source bus lines SL2k−1 and SL2k, that is, the amount ΔV0 of voltage drop in the output waveform due to the field-through phenomenon becomes smaller as the size (channel width W0) of the sub-selection transistor Ms0 (Ma0, Mb0) is reduced. However, as shown in FIG. 6A, since the size (channel width W1) of the main selection transistor Ms1 becomes larger as the size (channel width W0) of the sub-selection transistor Ms0 is reduced, a feed-through voltage ΔV1 at the main connection off point in time T1off becomes large, and the recovery power of the sub-selection transistor Ms0 from the voltage dropped at that time also becomes weak. Therefore, even if the channel width W0 of the sub-selection transistor Ms0 is selected such that the feed-through voltage ΔV0 at the sub-connection off point in time T0off which is the end point in time of charging of the source bus line is minimized, the amount ΔVs of voltage drop of the output waveform after the end of charging of the source bus line (after the sub-connection off point in time T0off) from the target voltage (voltage of the input waveform), that is, the substantial feed-through voltage ΔVs is not minimized.

FIG. 6B shows a simulation result of the relationship between the combination (TFT size (W1/W0)) of the channel width W1 of the main selection transistor Ms1 and the channel width W0 of the sub-selection transistor Ms0 and the substantial feed-through voltage ΔVs, assuming that the connection off time difference ΔToff=T0off−T1off is fixed at 1.0 μs.

In the simulation results shown in FIGS. 6A and 6B as described above, when the channel width W1 of the main selection transistor Ms1 is 30 μm and the channel width W0 of the sub-selection transistor Ms0 is 20 μm, the substantial feed-through voltage ΔVs is minimized. Therefore, hereinafter, W1=30 μm and W0=20 μm are regarded as the optimum combination of the channel width W1 of the main selection transistor Ms1 and the channel width W0 of the sub-selection transistor Ms0.

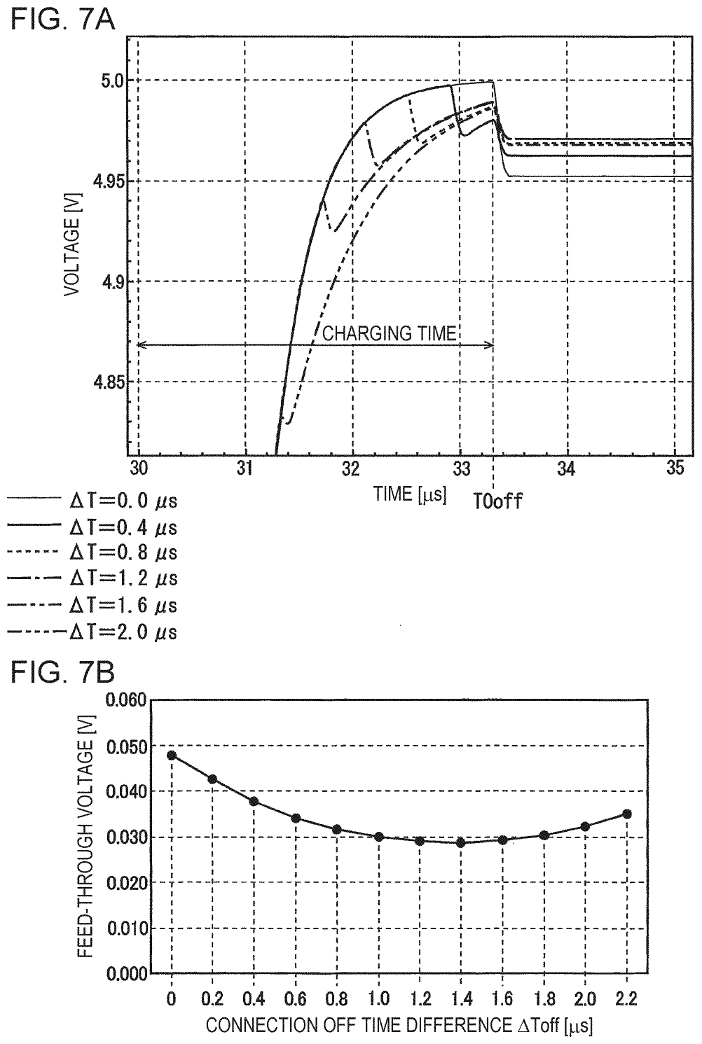

FIG. 7A is a signal waveform diagram showing a simulation result of the charging operation of the source bus line when a time (hereinafter referred to as a “total charging time”) Tchg from the start of charging the source bus line connected to the main selection transistor Ms1 and the sub-selection transistor Ms0 by the voltage of the input waveform (from the 30 μs elapsed point in time) to the end of the charging at the sub-connection off point in time T0off is 3.2 μs, and the connection off time difference ΔToff=T0off−T1off is changed by changing the main connection off point in time T1off under the condition that the channel width W1 of the main selection transistor Ms1 is 30 μm and the channel width W0 of the sub-selection transistor Ms0 is 20 μm. FIG. 7B shows a simulation result of the relationship between the connection off time difference ΔToff and the substantial feed-through voltage ΔVs under the condition that the total charging time Tchg is 3.2 μs, the channel width W1 of the main selection transistor Ms1 is 30 μm, and the channel width W0 of the sub-selection transistor Ms0 is 20 μm.

When the connection off time difference ΔToff=T0off−T1off is “0”, the main selection transistor Ms1 and the sub-selection transistor Ms0 change to the off-state at the same time, and the feed-through voltage in the output waveform is maximized. As the connection off time difference ΔToff is increased, the time that can be secured for charging the source bus line via the sub-selection transistor Ms0 becomes long, so that the substantial feed-through voltage ΔVs can be reduced. However, as shown in FIGS. 7A and 7B, when the connection off time difference ΔToff exceeds half of the total charging time Tchg, the time for charging the source bus line via the main selection transistor Ms1 decreases and the source bus line is insufficiently charged. In the simulation results in FIGS. 7A and 7B, when the connection off time difference ΔToff is set to 1.4 μs, the substantial feed-through voltage ΔVs is minimized.

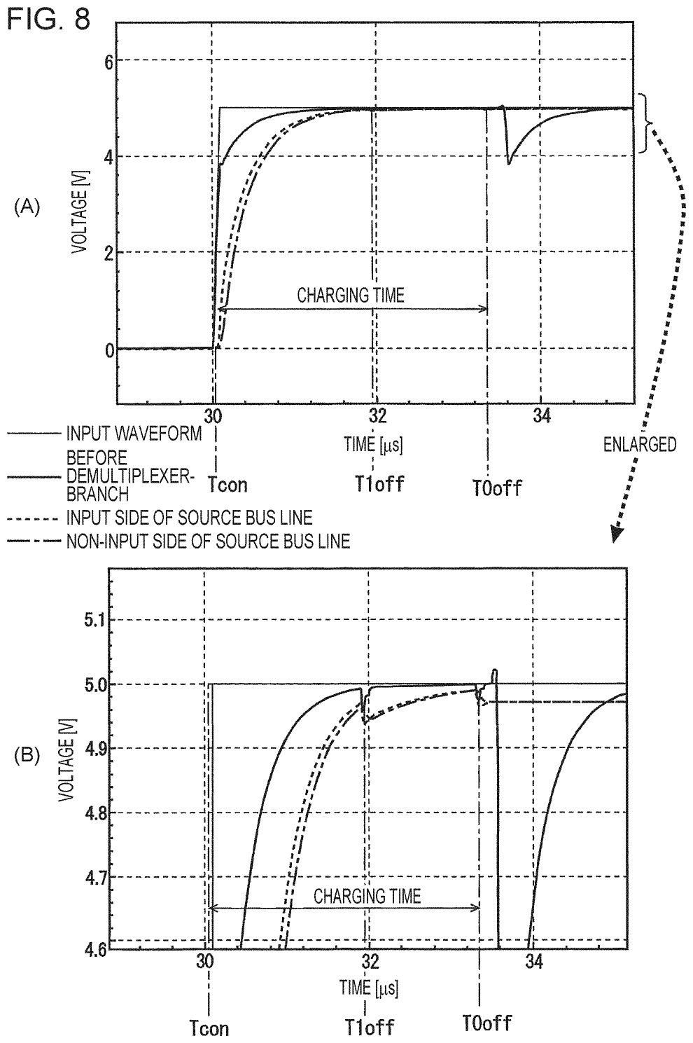

According to the above-described simulation results shown in FIGS. 6A, 6B, 7A, and 7B, in each demultiplexer 41k, it can be considered that when the channel width W1 of each of the main connection control transistors Ma1 and Mb1 is set to 30 μm, the channel width W0 of each of the sub-connection control transistors Ma0 and Mb0 is set to 20 μm, and the connection off time difference ΔToff is set to 1.4 μs, the substantial feed-through voltage ΔVs in the charging operation of the source bus line is minimized. Therefore, hereinafter, for convenience, these setting values will be referred to as “optimum setting values”. (A) of FIG. 8 is a signal waveform diagram showing an operation of the demultiplexing circuit 40 when using these optimum setting values in the present embodiment, and (B) of FIG. 8 is a signal waveform diagram in which the signal waveform diagram of (A) of FIG. 8 is enlarged in the vertical axis direction.

In (A) and (B) of FIG. 8, the thin solid line shows an input waveform of the demultiplexing circuit 40, that is, a waveform of the multiplexed data signal Dok output from the source bus line. The thick solid line shows a voltage waveform of the data output line DoLk at a position before branching by the demultiplexer 41k in the demultiplexing circuit 40 (hereinafter referred to as a “voltage waveform before demultiplexer-branch”). The thick dotted line shows a voltage waveform at an end, on a side to which the data signal is applied from the demultiplexing circuit 40, of both ends of the source bus line (hereinafter referred to as a “voltage waveform on the input side of the source bus line”). The thick one-dot chain line shows a voltage waveform at an end, on a side opposite to the side to which the data signal is applied from the demultiplexing circuit 40, of the both ends of the source bus line (hereinafter referred to as a “voltage waveform on the non-input side of the source bus line”). Further, the symbol “Tcon” indicates a point in time (hereinafter referred to as a “connection on point in time Tcon”) at which the transistor corresponding to the main selection transistor Ms1 in the main connection control transistors Ma1 and Mb1 and the transistor corresponding to the sub-selection transistor Ms0 in the sub-connection control transistors Ma0 and Mb0 change to the on-state. As shown in (B) of FIG. 8, during the period when the source bus line is being charged and immediately after the main connection off point in time T1off and the sub-connection off point in time T0off, although there is a difference between the voltage waveform on the input side of the source bus line and the voltage waveform on the non-input side of the source bus line, the same waveform is finally obtained.

In the above-described comparative example, the feed-through voltage in the charging operation of the source bus line (the amount of voltage drop due to the field-through phenomenon at the connection off point in time Tcoff) is minimized when the channel width W of the connection control transistor is 50 μm, and the feed-through voltage at this time is about 60 mV (see (B) in FIG. 5). In contrast, in the present embodiment, as described above, when the channel width W1 of each of the main connection control transistors Ma1 and Mb1 is 30 μm, the channel width W0 of each of the sub-connection control transistors Ma0 and Mb0 is 20 μm, and the connection off time difference ΔToff=T0off−T1off is 1.4 μs, the substantial feed-through voltage ΔVs in the charging operation of the source bus line is minimized (see in FIGS. 6A, 6B, and 7A), and the substantial feed-through voltage ΔVs at this time is about 29 mV (see FIG. 7B). That is, according to the present embodiment, the feed-through voltage at the time of charging the source bus line is reduced to about half that in the comparative example.

According to the present embodiment, since the feed-through voltage in the charging operation of the source bus line as the data signal line is significantly reduced in this way, even when the toggle-number reducing configuration is employed (see FIG. 3), it is possible to suppress deterioration of display quality. Therefore, in the liquid crystal display device including the active matrix substrate using the SSD method, it is possible to suppress deterioration of the display quality due to a feed-through phenomenon during charging of the source bus line while reducing power consumption by reducing the number of toggles in the demultiplexing circuit.

Note that, in above the first embodiment, the total W1+W0 of the channel width W1 of the main connection control transistors Ma1 and Mb1 and the channel width W0 of the sub-connection control transistors Ma0 and Mb0 is 50 μm, which is fixed (see FIG. 6B), but since power consumption is halved by halving the number of toggles in the demultiplexer 41k, W1, W0 and the connection off time difference ΔToff may be obtained such that the feed-through voltage is reduced as much as possible in the range where the corresponding total W1+W0 is less than twice the channel width W in the related art.

Further, in the first embodiment, voltage amplitudes of the main control signals ASW1 and BSW1 (5 V in the above case) and voltage amplitudes of the sub-control signals ASW0 and BSW0 are the same, but they do not necessarily have to be the same. For example, from the viewpoint of suppressing the feed-through voltage related to the source bus line when the sub-connection control transistors Ma0 and Mb0 change to the off-state (sub-connection off point in time T0off), the voltage amplitudes of the sub-control signals ASW0 and BSW0 may be smaller than the voltage amplitudes of the main control signals ASW1 and BSW1.

Further, in the first embodiment, the point in time when the A main control transistor Ma1 and the B main control transistor Mb1 are turned on (the point in time when the main control signals ASW1 and BSW1 change to the H level) and the point in time when the A sub-control transistor Ma0 and the B sub-control transistor Mb0 are turned on (the point in time when the sub-control signals ASW0 and BSW0 change to the H level) coincide with each other (see FIG. 3), but may be different. For example, the point in time when the B sub-control transistor Mb0 is turned on may be a period from immediately after the A main control transistor Ma1 and the A sub-control transistor Ma0 change to the off-state to immediately before the B main control transistor Mb1 changes to the off-state. Here, considering the efficiency of charging the source bus line by the data signal, it is preferable to make the point in time when the A sub-control transistor Ma0 and the B sub-control transistor Mb0 are turned on coincide with the point in time when the A main control transistor Ma1 and the B main control transistor Mb1 are turned on.

### 2. Second Embodiment

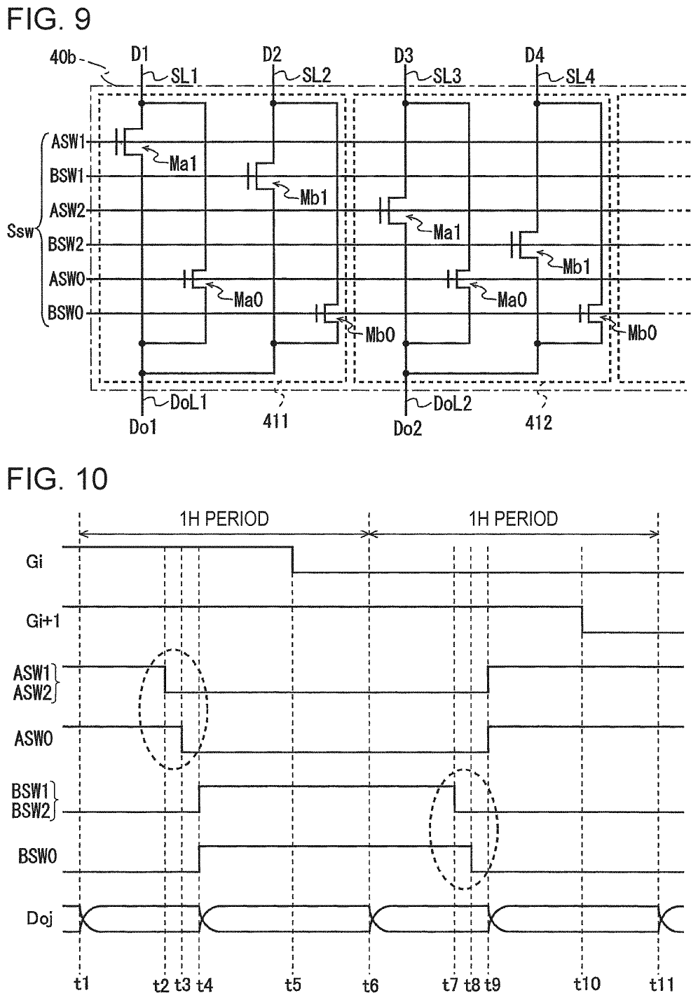

Next, a liquid crystal display device including an active matrix substrate using a monolithic SSD method according to a second embodiment will be described. FIG. 9 is a circuit diagram showing a configuration of a demultiplexing circuit 40b in the active matrix substrate according to the present embodiment. FIG. 10 is a signal waveform diagram for describing an operation of the demultiplexing circuit 40b. In the configuration of the liquid crystal display device including the active matrix substrate according to the present embodiment (hereinafter referred to as a “display device of the second embodiment”), the configuration of the parts other than the demultiplexing circuit 40b is almost the same as the configuration of the display device of the first embodiment (see FIGS. 1 to 3). Accordingly, the same or corresponding parts are designated by the same reference numerals, and detailed description thereof will be omitted.

As shown in FIG. 9, also in the present embodiment, similar to the demultiplexing circuit 40 in the first embodiment (see FIG. 2), each demultiplexer 41k (k=1 to m) in the demultiplexing circuit 40b includes the A main control transistor Ma1 and the B main control transistor Mb1 as main connection control transistors and the A sub-control transistor Ma0 and the B sub-control transistor Mb0 as sub-connection control transistors. However, as shown in FIG. 9, in the present embodiment, the demultiplexing control signal Ssw applied from the display control circuit 20 to the demultiplexing circuit 40b includes first and second A main control signals ASW1 and ASW2, first and second B main control signal BSW1 and BSW2, an A sub-control signal ASW0, and a B sub-control signal BSW0, and six signal lines for respectively transmitting these control signals ASW1, ASW2, BSW1, BSW2, ASW0, and BSW0 are arranged in the demultiplexing circuit 40b. In the odd-numbered demultiplexer 41(2j-1) such as the first demultiplexer 411, the first A main control signal ASW1 and the first B main control signal BSW1 are respectively applied to the gate terminals of the A main control transistor Ma1 and the B main control transistor Mb1, and in the even-numbered demultiplexer 41(2j) such as the second demultiplexer 412, the second A main control signal ASW2 and the second B main control signal BSW2 are respectively applied to the gate terminals of the A main control transistor Ma1 and the B main control transistor Mb1 (j=1 to m/2, and m is an even number). The A sub-control signal ASW0 and the B sub-control signal BSW0 are respectively applied to the gate terminals of the A sub-control transistor Ma0 and the B sub-control transistor Mb0 in the each demultiplexer 41k (k=1 to m).

In the present embodiment, as shown in FIG. 10, the demultiplexing control signal Ssw is generated in the display control circuit 20 such that the first A main control signal ASW1 and the first B main control signal BSW1 become the signal of the same waveform as the second A main control signal ASW2 and the second B main control signal BSW2, respectively.

Therefore, according to the present embodiment, the demultiplexing circuit 40b operates similarly to the demultiplexing circuit 40 in the first embodiment (see FIGS. 3 and 10), and the same effect can be obtained. In addition to this, according to the present embodiment, since the number of signal lines (control signal lines) for transmitting the demultiplexing control signal Ssw to the demultiplexers 411 to 41m is larger than that in the first embodiment, the load per one of these signal lines is reduced (the number of main connection control transistors Ma1 or Mb1 connected to each of the four signal lines transmitting the main connection control signals ASW1, BSW1, ASW2, and BSW2 is halved). Therefore, the bluntness of the waveforms of the main connection control signals ASW1, BSW1, ASW2, and BSW2 that constitute the demultiplexing control signal Ssw is reduced. As a result, the generation of the data signals D1 to D2m by demultiplexing the multiplexed data signals Do1 to Dom output from the source driver 30 and the application to the source bus lines SL1 to SL2m are performed more accurately, and the display quality in the display unit 101 is improved.

Note that, in the second embodiment, although four control signal lines are provided to control the main connection control transistors Ma1 and Mb1, and only two control signal lines are provided to control the sub-connection control transistors Ma0 and Mb0, the number of control signal lines to be provided in the demultiplexing circuit 40b is not limited thereto. More generally, the main connection control transistors to which the same main connection control signal is to be applied (m A main control transistors Ma1 or m B main control transistors Mb1) among 2m main connection control transistors Ma1 and Mb1 included in m demultiplexers 411 to 41m may be divided into two or more main connection control transistor groups, and two or more control signal lines may be provided to transmit the same main connection control signal to each of the two or more main connection control transistor groups. Further, for not only the main connection control transistors Ma1 and Mb1 but also the sub-connection control transistors Ma0 and Mb0, the number of control signal lines to be provided in the demultiplexing circuit 40b may be determined in consideration of the necessity of load distribution based on the sizes and the like. For example, when there is the necessity of load distribution for controlling the sub-connection control transistors Ma0 and Mb0, four control signal lines may be provided to control the sub-connection control transistors Ma0 and Mb0.

### 3. Third Embodiment

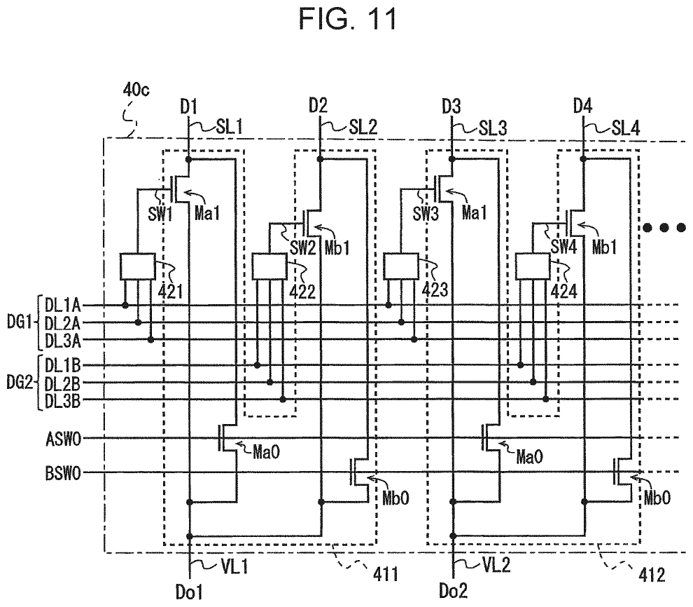

Next, a liquid crystal display device including an active matrix substrate using a monolithic SSD method according to a third embodiment will be described. FIG. 11 is a circuit diagram showing a configuration of a demultiplexing circuit 40c in the active matrix substrate according to the present embodiment. In the configuration of the liquid crystal display device including the active matrix substrate according to the present embodiment (hereinafter referred to as a “display device of the third embodiment”), the configuration of the parts other than the demultiplexing circuit 40c is almost the same as the configuration of the display device of the first embodiment (see FIGS. 1 and 2). Accordingly, the same or corresponding parts are designated by the same reference numerals, and detailed description thereof will be omitted. Hereinafter, the configuration and operation of the demultiplexing circuit 40c in the present embodiment will be described with reference to FIGS. 11 to 13.

As shown in FIG. 11, similar to each demultiplexer in the first embodiment, each demultiplexer 41k (k=1 to m) in the demultiplexing circuit 40c includes an A main control transistor Ma1 and a B main control transistor Mb1 that are respectively connected to two source bus lines SL2k−1 and SL2k of the set corresponding to the demultiplexer 41k, and an input terminal Tdk corresponding to the demultiplexer 41k is connected to the 2k−1-th source bus line SL2k−1 via the A main control transistor Ma1 and is connected to the 2k-th source bus line SL2k via the B main connection control transistor Mb1. Further, an A sub-control transistor Ma0 is connected in parallel to the A main control transistor Ma1, and a B sub-control transistor Mb0 is connected in parallel with the B main control transistor Mb1. On the other hand, unlike the demultiplexer in the first embodiment, each demultiplexer 41k in the present embodiment includes boost circuits 42(2k−1) and 42(2k) that respectively generate an A main control signal SW2k−1 and a B main control signal SW2k, which are to be respectively applied to the gate terminals of the A main control transistor Ma1 and the B main control transistor Mb1 (k=1 to m).

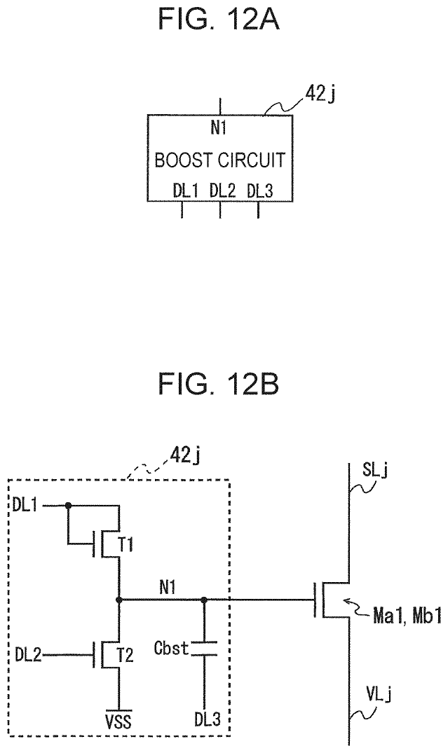

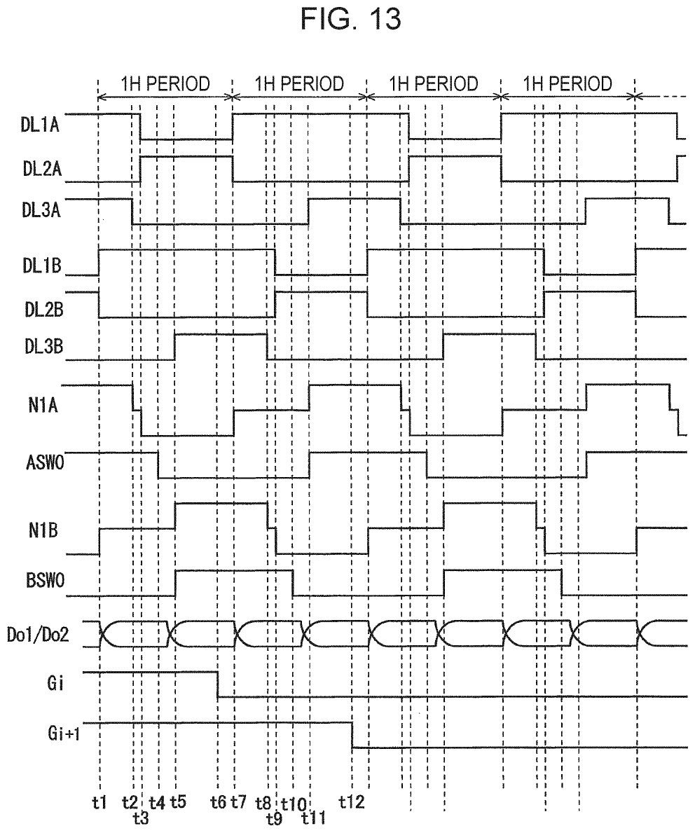

FIG. 12A is a diagram for describing terminals of a boost circuit 42j, and FIG. 12B is a circuit diagram showing a configuration of the boost circuit 42j (j=1 to 2m). FIG. 13 is a signal waveform diagram for describing an operation of the demultiplexing circuit 40c.

In the present embodiment, the demultiplexing control signal Ssw applied to the demultiplexing circuit 40c includes two types of main control signals DG1 and DG2 and two sub-connection control signals ASW0 and BSW0 (A sub-control signal ASW0 and B sub-control signal BSW0), as shown in FIG. 13. One main control signal DG1 of the two types of main control signals DG1 and DG2 includes first to third A boost control signals DL1A to DL3A and the other main control signal DG2 includes first to third B boost control signals DL1B to DL3B.

As shown in FIG. 11, in two main connection control transistors Ma1 and Mb1 included in each demultiplexer 41k, the first to third A boost control signals DL1A to DL3A are input to the boost circuit 42(2k−1) that generates the A main control signal SW2k−1 to be applied to the gate terminal of the A main control transistor Ma1 and the first to third B boost control signals DL1B to DL3B are input to the boost circuit 42(2k) that generates the B main control signal SW2k to be applied to the gate terminal of the B main control transistor Mb1. Note that, similarly to the demultiplexing circuit 40 in the first embodiment, in each demultiplexer 41k, the A sub-control signal ASW0 is applied to the gate terminal of the A sub-control transistor Ma0, and the B sub-control signal BSW0 is applied to the gate terminal of the B sub-control transistor Mb0.

As shown in FIG. 12A, each boost circuit 42j (j=1 to 2m) has first to third input terminals DL1, DL2, and DL3 as input terminals and also has one output terminal N1, which is configured as shown in FIG. 12B. That is, each boost circuit 42j includes two N-channel TFTs (hereinafter simply referred to as “transistors”) T1 and T2 and a boost capacitor Cbst. The transistor T1 is a charging transistor of a type in which its gate terminal is connected to its drain terminal, that is, a diode-connected type, the drain terminal and the gate terminal are connected to the first input terminal DL1, and the source terminal is connected to the drain terminal of the transistor T2. The transistor T2 functions as a discharging switching element, and its gate terminal is connected to the second input terminal DL2 and its source terminal is grounded (is connected to a low-voltage side power supply line VSS). An internal node N1 including the connection point between the transistor T1 and the transistor T2 is connected to the third input terminal DL3 via the boost capacitor Cbst. Further, the internal node N1 is connected to the output terminal N1, and as shown in FIGS. 11 and 12B, the voltage of the internal node N1 is applied to the main connection control transistor Ma1 or Mb1 as a main connection control signal (A main control signal or B main control signal) SWj (j=1 to 2m).

As can be seen from FIG. 11 and FIGS. 12A and 12B, in a boost circuit (hereinafter referred to as an “A boost circuit”) 42ja that generates an A main control signal SWja (ja=1, 3, 5, . . . , 2m−1), the first to third A boost control signals DL1A to DL3A are applied to the first to third input terminals DL1 to DL3, respectively, and in a boost circuit (hereinafter referred to as a “B boost circuit”) 42jb that generates a B main control signal SWjb (jb=2, 4, 6, . . . , 2m), the first to third B boost control signals DL1B to DL3B are applied to the first to third input terminals DL1 to DL3, respectively. Further, the voltage of an internal node N1A (internal node N1) in the A boost circuit 42ja is applied as the A main control signal SWja to the gate terminal of the A main control transistor Ma1 via the output terminal N1, and the voltage of an internal node N1B (internal node N1) in the B boost circuit 42jb is applied as the B main control signal SWjb to the gate terminal of the B main control transistor Mb1 via the output terminal N1.

The demultiplexing circuit 40c including the boost circuits 421 to 42(2m) configured as described above operates as follows based on the demultiplexing control signal Ssw from the display control circuit 20, that is, the first to third A b boost control signals DL1A to DL3A, the first to third B boost control signals DL1B to DL3B, the A sub-control signal ASW0, and the B sub-control signal BSW0 as shown in FIG. 13. Hereinafter, the operation of the demultiplexing circuit 40c will be described by focusing on the A boost circuit 421 and the B boost circuit 422 shown in FIG. 11.

The A main control transistor Ma1 to which the A main control signal SW1 generated by the A boost circuit 421 is applied and the B main control transistor Mb1 to which the B main control signal SW2 generated by the B boost circuit 422 is applied constitutes the first demultiplexer 411, and a signal obtained by time-division multiplexing the data signals D1 and D2 to be respectively applied to the two source bus lines SL1 and SL2 is applied as the multiplexed data signal Do1 via a data output line VL1 to the input terminal of the demultiplexer 411. More specifically, for the first demultiplexer 411, in one of the first half and the second half of each horizontal period (1H period), the voltage of the data signal D1 is applied to the demultiplexer 411 via the data output line VL1, and in the other period, the voltage of the data signal D2 is applied to the demultiplexer 411 via the data output line VL1. The same applies to the other demultiplexers 412 to 41m.

As shown in FIG. 13, at a start point in time t1 (time t1) of a certain 1H period, the first B boost control signal DL1B in the demultiplexing control signal Ssw changes from the L level to the H level. Thereby, the internal node N1B of the B boost circuit 422 is precharged via a diode-connected transistor T1B (see FIG. 12B). Further, at this time, the second B boost control signal DL2B in the demultiplexing control signal Ssw changes from the H level to the L level, whereby the transistor T2 of the B boost circuit 422 enters the off-state.

After that, at time t2, the third A boost control signal DL3A in the demultiplexing control signal Ssw changes from the H level to the L level, and at the time t3, the first A boost control signal DL1A changes from the H level to the L level and the second A boost control signal DL2A changes from the L level to the H level. In response to this, the voltage of the internal node N1A of the A boost circuit 421 is reduced and becomes the L level at time t3. Thereby, the A main control transistor Ma1 enters the off-state. After that, at time t4, the A sub-control signal ASW0 changes from the H level to the L level, whereby the A sub-control transistor Ma0 also enters the off-state. Note that, the time from time t3 to time t4 corresponds to the connection off time difference ΔToff=T0off−T1off in the first embodiment (see FIGS. 6A and 7B).

After that, at time t5, the third B boost control signal DL3B in the demultiplexing control signal Ssw changes from the L level to the H level, whereby the voltage of the internal node N1B of the B boost circuit 422 is boosted via the boost capacitor Cbst (see FIG. 12B), and becomes a voltage higher than the voltage of the H level, that is, a voltage of a boost H level. Therefore, after time t5, the B main control transistor Mb1 is in the on-state by applying the voltage of the boost H level to the gate terminal as the B main control signal SW2. Note that, at time t5, the B sub-control signal BSW0 also changes to the H level, whereby the B sub-control transistor Mb0 also enters the on-state.

At a predetermined point in time from time t4 to time t5, the voltage applied from the source driver 30 to the data output line VL1 changes from the voltage of the data signal D1 to be applied to the source bus line SL1 to the voltage of the data signal D2 to be applied to the source bus line SL2. Therefore, after time t5, the voltage of the data signal D2 is applied to the source bus line SL2 by two paths of a path via the B main control transistor Mb1 that is in the on-state by the voltage of the boost H level at the internal node N1B and a path via the B sub-control transistor Mb0 in the on-state.

After that, at time t6, the i-th scanning signal Gi changes from the H level to the L level, and the i-th gate bus line GLi enters the non-selected state. Thereby, the writing of the voltage held in the second source bus line SL2 to the pixel forming unit 10 corresponding to the i-th gate bus line GLi and the first source bus line SL1 is ended.

At time t7 when the 1H period ends and the next 1H period (hereinafter referred to as a “second 1H period”) starts, the voltage applied from the source driver 30 to the data output line VL1 changes to the voltage of the data signal D2 of the next display line to be applied to the source bus line SL2. At this time, since the B main control transistor Mb1 and the B sub-control transistor Mb0 are maintained in the on-state, the voltage of the data signal D2 is applied to the source bus line SL2 after time t7.

Further, at time t7, the first A boost control signal DL1A in the demultiplexing control signal Ssw changes from the L level to the H level. Thereby, the internal node N1A of the A boost circuit 421 is precharged via a diode-connected transistor T1A (see FIG. 12B). Further, at this time, the second A boost control signal DL2A in the demultiplexing control signal Ssw changes from the H level to the L level, whereby the transistor T2 of the A boost circuit 421 enters the off-state.

After that, at time t8, the third B boost control signal DL3B in the demultiplexing control signal Ssw changes from the H level to the L level, and at the time t9, the first B boost control signal DL1B changes from the H level to the L level and the second B boost control signal DL2B changes from the L level to the H level. In response to this, the voltage of the internal node N1B of the B boost circuit 422 is reduced and becomes the L level at time t9. Thereby, the B main control transistor Mb1 enters the off-state. After that, at time t10, the B sub-control signal BSW0 changes from the H level to the L level, whereby the B sub-control transistor Mb0 also enters the off-state. Note that, the time from time t9 to time t10 corresponds to the connection off time difference ΔToff=T0off−T1off in the first embodiment (see FIGS. 6A and 7B).

After that, at time t11, the third A boost control signal DL3A in the demultiplexing control signal Ssw changes from the L level to the H level, whereby the voltage of the internal node N1A of the A boost circuit 421 is boosted via the boost capacitor Cbst (see FIG. 12B), and becomes the voltage higher than the voltage of the H level, that is, the voltage of the boost H level. Therefore, after time t11, the A main control transistor Ma1 is in the on-state by applying the voltage of the boost H level to the gate terminal as the A main control signal SW1. Note that, at time t11, the A sub-control signal ASW0 also changes to the H level, whereby the A sub-control transistor Ma0 also enters the on-state.

At a predetermined point in time from time t10 to time t11, the voltage applied from the source driver 30 to the data output line VL1 changes from the voltage of the data signal D2 to be applied to the source bus line SL2 to the voltage of the data signal D1 to be applied to the source bus line SL1. Therefore, after time t11, the voltage of the data signal D1 is applied to the source bus line SL1 by two paths of a path via the A main control transistor Ma1 that is in the on-state by the voltage of the boost H level at the internal node N1A and a path via the A sub-control transistor Ma0 in the on-state.

After that, at time t12, the i+1-th scanning signal Gill changes from the H level to the L level, and the i+1-th gate bus line GLi+1 enters the non-selected state. Thereby, the writing of the voltage held in the first source bus line SL1 to the pixel forming unit 10 corresponding to the i+1-th gate bus line GLi+1 and the first source bus line SL1 is ended.

The other demultiplexers 412 to 41m in the demultiplexing circuit 40c also operate in the same manner as above. As described above, for each 1H period, the voltages of the multiplexed data signals Do1 to Dom output from the source driver 30 are demultiplexed and respectively applied to and held by the source bus lines SL1 to SL2m as the voltages of the data signals D1 to D2m. In such a demultiplexing operation, in the transistor Ms1 to be in the on-state of the main connection control transistors Ma1 and Mb1 of the present embodiment, the voltage of the boost H level generated by the boost circuit 42j is applied to the gate terminal of the transistor Ms1. In this way, the voltages respectively applied to and held by the source bus lines SL1 to SL2m are line-sequentially written as data voltages in the n×2m pixel forming units 10 of the display unit 101 in accordance with the scanning of the gate bus lines GL1 to GLn.

According to the present embodiment as described above, each demultiplexer 41k includes sub-connection control transistors Ma0 and Mb0 in addition to the main connection control transistors Ma1 and Mb1 as in the first embodiment, by configuring the size and the control of the main connection control transistors Ma1 and Mb1 and the sub-connection control transistors Ma0 and Mb0 such that the feed-through voltage related to the source bus line is minimized by the operation of the demultiplexer 41k, the same effect as in the first embodiment can be obtained. In addition to this, according to the present embodiment, in each demultiplexer 41k, the voltage of the boost H level generated by the boost circuit 42j is applied to the gate terminal of the transistor Ms1 to be in the on-state of the main connection control transistors Ma1 and Mb1. Therefore, it is possible to realize an active matrix substrate compatible with the monolithic SSD method while reducing the size of the TFT as a switching element that constitutes each demultiplexer 41k from the one in the related art.

Therefore, in a display device, which is driven by a monolithic SSD method, using a TFT in which a channel layer is formed of a material having a relatively low mobility, such as an oxide semiconductor, power consumption can be reduced while suppressing an increase in frame size.

Note that, the sub-connection control transistors Ma0 and Mb0 are provided to suppress the feed-through voltage and do not need to have a large charging capacity. Therefore, it is not necessary to provide a circuit for boosting the sub-control signals ASW0 and BSW0 to be applied to the gate terminals of the sub-connection control transistors Ma0 and Mb0, and from the viewpoint of reducing the feed-through voltage related to the source bus line, it is preferable that the voltage amplitudes of the sub-control signals ASW0 and BSW0 are small. Here, when it is necessary to provide a circuit due to the characteristics of the transistors used as sub-connection control transistors Ma0 and Mb0, a circuit for boosting the sub-control signals ASW0 and BSW0 to be applied to the gate terminals of the sub-connection control transistors Ma0 and Mb0 may be provided.

Further, the configuration of the demultiplexing circuit using the boost circuit is not limited to the configuration shown in FIG. 11. That is, the configuration in which the sub-connection control transistors Ma0 and Mb0 are provided in each demultiplexer 41k in addition to the main connection control transistors Ma1 and Mb1 to suppress the feed-through voltage related to the source bus line is also applicable to a demultiplexing circuit including a boost circuit having a configuration different from the configurations shown in FIGS. 11, 12A, and 12B. For example, for the main connection control transistors to which the same main connection control signal is to be applied (m A main control transistors Ma1 or m B main control transistors Mb1) among 2m main connection control transistors Ma1 and Mb1 included in the demultiplexing circuit, a natural number of boost circuits smaller than m may be provided to generate the same main connection control signal.

### 4. Modification Example

Although the present disclosure has been described in detail above, the above description is illustrative in all aspects and not restrictive. It is understood that numerous other modifications and variations can be devised without departing from the scope of the present disclosure.

For example, in the active matrix substrate according to each of the above embodiments, the demultiplexing circuit is realized using only N-channel TFTs, but the present disclosure is not limited thereto. For example, a circuit such as the demultiplexing circuit in the active matrix substrate according to each of the above embodiments may be realized using only P-channel TFTs. In this case, the configuration related to the polarity of the voltage is different from that of each of the above embodiments, but since the specific configuration is apparent to those skilled in the art, the details will be omitted.

Further, the demultiplexing circuit usable in the present disclosure is not limited to the one configured and controlled as shown in FIGS. 2, 3, and 9 to 13. That is, as long as the sub-connection control transistors Ma0 and Mb0 are provided in each demultiplexer 41k (k=1 to m) in addition to the main connection control transistors Ma1 and Mb1 to suppress the feed-through voltage related to the source bus line, a demultiplexing circuit having another configuration may be used. For example, in the present embodiment, the source bus line group corresponding to each demultiplexer 41k includes two source bus lines SL2k−1 and SL2k adjacent to each other. However, in the case of applying the present disclosure to a liquid crystal display device, in consideration of inversion driving, the source bus line group corresponding to each demultiplexer 41k may include two source bus lines SLj and SLj+2, which are alternately selected. Further, for example, the source bus line group of the set corresponding to each demultiplexer 41k may include three or more source bus lines.

Note that, the display devices according to various modification examples can be configured by optionally combining the features of the display devices according to the above-described embodiments and the modification examples thereof, as long as the characteristics thereof are not violated.

Hereinabove, the liquid crystal display device, which is driven by an SSD method, using the active matrix substrate has been described as an example. However, the present disclosure is not limited thereto, and is also applicable to a display device other than the liquid crystal display device, for example, an organic electroluminescence (EL) display device as long as it is a display device driven by an SSD method.

The present disclosure contains subject matter related to that disclosed in US Provisional Patent Application No. 62-925792 filed in the US Patent Office on Oct. 25, 2019, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device that includes an active matrix substrate provided with a plurality of data signal lines, a plurality of scanning signal lines intersecting the plurality of data signal lines, and a plurality of pixel forming units arranged along the plurality of data signal lines and the plurality of scanning signal lines, the display device comprising:
a demultiplexing circuit that includes a plurality of demultiplexers respectively corresponding to a plurality of sets of data signal line groups obtained by dividing the plurality of data signal lines into groups with two or more data signal lines making up one set, and a plurality of input terminals respectively corresponding to the plurality of demultiplexers;
a data drive circuit that applies, to each of the plurality of input terminals, a signal into which two or more data signals are time-division multiplexed as a multiplexed data signal, the two or more data signals being respectively applied to the two or more data signal lines in the set corresponding to the input terminal, among a plurality of data signals representing an image to be displayed; and
a demultiplexing control circuit that generates a demultiplexing control signal for controlling the demultiplexing circuit such that the plurality of data signals are respectively applied to the plurality of data signal lines, wherein each of the plurality of demultiplexers includes:
two or more main switching elements respectively corresponding to the two or more data signal lines in the corresponding set, the main switching elements each having a first conduction terminal connected to the corresponding data signal line, a second conduction terminal connected to the input terminal corresponding to the demultiplexer, and a control terminal for receiving a connection control signal for switching between an on-state and an off-state based on the demultiplexing control signal; and
two or more sub-switching elements respectively corresponding to the two or more main switching elements, the sub-switching elements each having first and second conduction terminals respectively connected to the first and second conduction terminals of the corresponding main switching element, and a control terminal for receiving a connection control signal for switching between the on-state and the off-state based on the demultiplexing control signal, and
the demultiplexing control circuit generates the demultiplexing control signal such that each of the two or more sub-switching elements included in each of the plurality of demultiplexers is turned off at a point in time later than a point in time when the corresponding main switching element is turned off.

2. The display device according to claim 1, wherein each of the plurality of main switching elements and the plurality of sub-switching element includes a field effect transistor.

3. The display device according to claim 2, wherein the field effect transistor of each of the plurality of main switching elements and the plurality of sub-switching elements is a thin film transistor in which a channel layer is formed of an oxide semiconductor.

4. The display device according to claim 2, wherein a channel width of the field effect transistor of each of the plurality of sub-switching elements is smaller than a channel width of the field effect transistor of each of the plurality of main switching elements.

5. The display device according to claim 1, wherein the demultiplexing circuit further includes two or more signal lines for dividing the main switching elements to which the same connection control signal is to be applied into two or more main switching element groups, among the main switching elements included in the plurality of demultiplexers, and respectively transmitting the same connection control signal to the two or more main switching element groups.

6. The display device according to claim 1, wherein the demultiplexing control circuit generates the demultiplexing control signal such that each of the two or more sub-switching elements and the corresponding main switching element change to the on-state at the same time.

7. The display device according to claim 1, wherein demultiplexing control circuit generates the demultiplexing control signal such that a voltage amplitude of the connection control signal applied to the control terminal of each of the two or more sub-switching elements is smaller than a voltage amplitude of the connection control signal applied to the control terminal of the corresponding main switching element.

8. The display device according to claim 1, wherein the demultiplexing circuit further includes a plurality of boost circuits that generate a connection control signal to be applied to the control terminals of the main switching elements included in the plurality of demultiplexers based on the demultiplexing control signal, as a signal of a voltage boosted to be higher than a voltage of the demultiplexing control signal.

9. The display device according to claim 8, wherein each of the plurality of boost circuit includes:
an internal node connected to the control terminal of the main switching element to which the connection control signal to be generated is to be applied;
a diode-connected charging transistor for charging the internal node,
a discharging switching element for discharging the internal node;
a boost capacitor;
a first input terminal connected to the internal node via the charging transistor;
a second input terminal connected to a control terminal of the discharging switching element; and
a third input terminal connected to the internal node via the boost capacitor,
the demultiplexing control signal includes a plurality of boost control signals, and
the demultiplexing circuit is configured such that among the plurality of boost control signals, three boost control signals for the connection control signal to be generated by the corresponding boost circuit are respectively applied to the first, second, and third input terminals of each of the plurality of boost circuits.

10. The display device according to claim 1, wherein the demultiplexing circuit is integrally formed with the plurality of pixel forming units on the active matrix substrate.

11. A drive method of a display device that includes an active matrix substrate provided with a plurality of data signal lines, a plurality of scanning signal lines intersecting the plurality of data signal lines, and a plurality of pixel forming units arranged along the plurality of data signal lines and the plurality of scanning signal lines, the display device including
a demultiplexing circuit that includes a plurality of demultiplexers respectively corresponding to a plurality of sets of data signal line groups obtained by dividing the plurality of data signal lines into groups with two or more data signal lines making up one set, and a plurality of input terminals respectively corresponding to the plurality of demultiplexers,
each of the plurality of demultiplexers including
two or more main switching elements respectively corresponding to the two or more data signal lines in the corresponding set, the main switching elements each having a first conduction terminal connected to the corresponding data signal line, a second conduction terminal connected to the input terminal corresponding to the demultiplexer, and a control terminal for receiving a connection control signal for switching between an on-state and an off-state, and
two or more sub-switching elements respectively corresponding to the two or more main switching elements, the sub-switching elements each having first and second conduction terminals respectively connected to the first and second conduction terminals of the corresponding main switching element, and a control terminal for receiving a connection control signal for switching between the on-state and the off-state,
the drive method comprising:
applying, to each of the plurality of input terminals, a signal into which two or more data signals are time-division multiplexed as a multiplexed data signal, the two or more data signals being respectively applied to the two or more data signal lines in the set corresponding to the input terminal, among a plurality of data signals representing an image to be displayed; and
controlling the main switching elements and the sub-switching elements in the demultiplexing circuit such that the plurality of data signals are respectively applied to the plurality of data signal lines, wherein
in the controlling, the two or more main switching elements and the two or more sub-switching elements are controlled such that each of the two or more sub-switching elements included in each of the plurality of demultiplexers is turned off at a point in time later than a point in time when the corresponding main switching element is turned off.
